(19) United States
(12) Patent Application Publication
(10) Pub. No.: US 2020/0129788 A1
(43) Pub. Date: Apr. 30, 2020

(54) RESPIRATOR MASK

(71) Applicant: JINFUYU INDUSTRIAL CO., LTD., New Taipei City (TW)

(72) Inventors: Ming Li Tu, New Taipei City (TW); Yu Yu Lai, New Taipei City (TW)

(73) Assignee: JINFUYU INDUSTRIAL CO., LTD., New Taipei City (TW)

(21) Appl. No.: 16/177,420

(22) Filed: Oct. 31, 2018

(51) Int. Cl. A62B 23/02; A62B 7/10; A62B 18/02

(52) U.S. Cl. CPC A62B 23/025; A62B 18/025; A62B 7/10

(57) ABSTRACT

The present disclosure provides a respirator mask adapt to cover the mouth and the nose of a user. The respirator mask comprises a mask body and a filter unit. The mask body has a ventilation opening, and an end face of the ventilation opening forms a ventilation flux surface. The filter unit comprises a filter portion and a connection portion, wherein the filter portion comprises a plurality of connection sheets jointly forming a folding structure. The folding structure forms a fold flux surface, wherein an area of the fold flux surface is bigger than that of the ventilation flux surface. The ventilation opening is sealed by the filter unit. The respirator mask of the present invention has the fold flux surface which increases the flux area to make enough air flux pass through the respirator mask and prevent a user from having difficulty in breathing with the respirator mask.

### FIELD OF THE DISCLOSURE

The present disclosure relates to a respirator mask, and more particularly, to a respirator mask with increased surface area, such that most of the air avoids being blocked by the respirator mask when a user breathes in or out the air and the user easily breathes in and out the air while wearing the respirator mask.

### BACKGROUND

With the development of industry and the transportation progress, they bring about exhaust emissions from factories and vehicles in the living environment. The exhaust affects the ecological environment and pollutes the air more seriously, causing people to be affected by smog for a long time. In order to avoid breathing in pollutants and bacteria in the air to endanger the health, people will wear a respirator mask when they go out to work, go to school, travel or shop.

Wherein a respirator mask is used to be worn onto the mouth and the nose of a user, and the respirator mask can block and filter out the dirt and bacteria in the space to make the user breathe in clear air. In addition, when the user breathes out the air, the respirator mask also can filter the air exhaled by the user to avoid spreading bacteria in the air further to infect other people. However, at present, most of the commercially available respirator masks are worn on the user's mouth and nose, the form size of the mask will not change much. When the user exhales and inhales, the mask has only a specific area for air to pass through, and most of the air is blocked by the respirator mask, making the user have difficulty in exhalation and inhalation while wearing the respirator mask.

However, in order to improve the defect of user's having difficulty in exhalation and inhalation while wearing the respirator mask. At present, there is a conventional three-dimensional respirator mask 1 equipped with a piston valve body 11 on the market. Please refer to FIG. 1A. The conventional three-dimensional respirator mask 1 comprises a three-dimensional mask body 10 and a piston valve body 11. The three-dimensional mask body 10 is used to cover the mouth and the nose of the user and is made of an air permeable material. An opening 101 forms through the three-dimensional mask body 10 and is aligned with the position around the mouth and the nose of the user, and the piston valve body 11 is installed at the periphery of the opening 101 and arranged with a flap 111 (as shown in FIG. 1B) having a contour smaller than the opening 101. The flap 111 is located at exterior of the three-dimensional mask body 10 and able to optionally cover the opening 101.

Please refer to FIG. 1B. During practical application of the three-dimensional mask body 10, the three-dimensional mask body 10 is worn onto the mouth and the nose of the user to make the piston valve body 11 located at one side of the mouth and the nose of the user. When the user exhales, the air in the user's mouth could push the flap 111 away from the opening 101 of the three-dimensional mask body 10, such that most of the air in the mouth of the user can be discharged to external space from the opening 101 and the user can easily breathe out the air while wearing the conventional three-dimensional respirator mask 1. However, when the user inhales, the external air could push the flap 111 close to the opening 101, such that the flap 111 would completely cover the opening 101 and the external air cannot flow into the mouth of the user from the opening 101 but only can flow into the mouth of the user from the opening 101 three-dimensional mask body 10. Therefore the user can only breathe in little air while wearing the conventional three-dimensional respirator mask 1 and the user relatively feels difficult to breathe in the air, which causes the user to increase the times of inhalation for desired air volume.

### SUMMARY

The main purpose of the present invention is to improve the structure of a respirator mask so as to increase the surface area of the respirator mask. When a user breathes in and out the air while wearing the respirator mask, most of the air can flow through the respirator mask because of more area through which the air can flow, which prevents the respirator mask from blocking most of the air. Therefore, the user easily breathes in and out the air while wearing the respirator mask.

Given a conventional three-dimensional respirator mask equipped with a piston valve, the secondary purpose of the present invention is to improve the structure and design a new structure able to replace the piston valve. Thus, most of the air can flow through the respirator mask whether the user exhales or inhales while wearing the respirator mask, and the resistance of exhalation and inhalation are reduced.

Yet another purpose of the present invention is to improve the entire appearance of a respirator mask, which increases the aesthetics of the respirator mask. Therefore, the respirator mask is not only aesthetic, but also allows the user to easily exhale or inhale while wearing the respirator mask.

To achieve above purposes, the present invention relates a respirator mask for covering the mouth and the nose of a user. The respirator mask mainly comprises a mask body and a filter unit. The mask body is arranged with a ventilation opening. An end face of the ventilation opening forms a vent flux surface through which the air can flow. Wherein, the filter unit comprises a filter portion able to filter out the dirt and a connection portion forming at the periphery of the filter portion. The filter portion is arranged with a plurality of connection sheets connecting with each other for making the filter portion show a folding structure able to change form and surface areas of the plurality of connection sheets jointly constitute a fold flux surface through which the air can flow. An area of the fold flux surface is larger than that of the vent flux surface. The connection portion is attached to the mask body such that the filter portion is aligned with the ventilation opening and the filter unit further seals the ventilation opening.

In one preferable embodiment, the mask body includes a curve portion showing a three dimensional form and a plane portion showing a flat form. The plane portion forms at one end of the curve portion close to the ventilation opening. The plane portion is arranged with the ventilation opening and is used to attached to the connection portion of the filter unit.

In another preferable embodiment, the mask body comprises a plurality of sheet bodies connecting with each other. The plurality of sheet bodies can be unfolded to change the relative position between the sheet body and one other sheet body, such that a state of the mask body changes into an unfolded state with three-dimensional from a collapsed state with flat form. And the ventilation opening is formed on one of the sheet bodies.

In previous two embodiments, when the user exhales, the plurality of connection sheets could deform to change a contour of the fold flux surface, such that the vent flux surface intersects with the fold flux surface.

Furthermore, opposite ends of the connection sheet each separately connect with one other connection sheet, such that every connection between two of the connection sheets separately forms a bend segment in the filter portion. The connection sheets are all located at the same side of the vent flux surface or are distributed at opposite sides of the vent flux surface. In addition, the filter portion has a size corresponding to a diameter of the ventilation opening and the connection portion is at the periphery of the filter portion, such that the connection portion has a contour diameter larger than the diameter of the ventilation opening and the connection portion further overlaps the mask body.

In previous two embodiments, the respirator mask further comprises a covering body having a form larger than the ventilation opening. A part of the covering body forms a joint portion attached to one side of the mask body opposite to the connection portion, such that the remaining part of the covering body forms a covering portion at the center of the joint portion to cover the ventilation opening.

In preferable embodiments, the covering portion can optionally move away from or close to the ventilation opening. An accommodation space is formed between the covering portion and the mask body and a size of the accommodation space can be enlarged or reduced as the covering portion moves away from or close to the ventilation opening. The plurality of connection sheets can deform to enter the interior of the accommodation space when the user exhales, wherein the mask body and the covering body are made of the same air permeable material while the filter unit and the mask body are made of different air permeable materials. In addition, the air permeability of the filter unit is better than that of the mask body.

The present invention features a fold flux surface which is formed with joint surfaces of a plurality of connection sheets. When a user exhales or inhales while wearing the respirator mask, the air not only can flow through the mask body, but also can flow through the fold flux surface, such that a surface area of the respirator mask increases. Therefore, the respirator mask has more areas through which the air can flow to prevent the respirator mask from blocking most of the air, such that the user can easily exhale and inhale while wearing the respirator mask.

Furthermore, the present invention designs a filter unit able to replace a piston valve. The filter unit has a filter portion comprising a plurality of connection sheets to increase a surface area of the respirator mask, such that the respirator mask has more areas through which the air can flow. Therefore, most of the air can flow through the respirator mask whether the user exhales or inhales while wearing the respirator mask, and the resistance of exhalation and inhalation are reduced.

Furthermore, the covering body is attached to the a mask body to make the covering portion of the covering body cover the ventilation opening, such that entire appearance of the respirator mask is improved and the aesthetics of the respirator mask is increased. Therefore, the respirator mask is not only aesthetic, but also allows the user to easily exhale or inhale while wearing the respirator mask.

### BRIEF DESCRIPTION OF THE DRAWINGS

To more clearly illustrate embodiments of the application or technical solutions in the prior art, drawings to be used in the description of the embodiments of the application or the prior art will be briefly introduced hereinafter. Apparently, the drawings in the description below are merely some embodiments of the disclosure, a person skilled in the art can obtain other drawings according to these drawings without creative efforts. In the figures:

FIG. 1A is a schematic illustrating a conventional three-dimensional respirator mask;

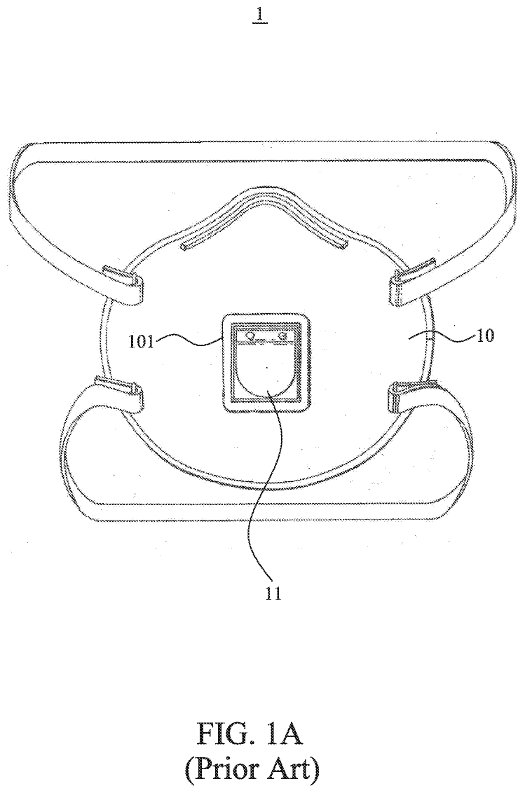

FIG. 1B is a schematic illustrating the usage of the conventional three-dimensional respirator mask;

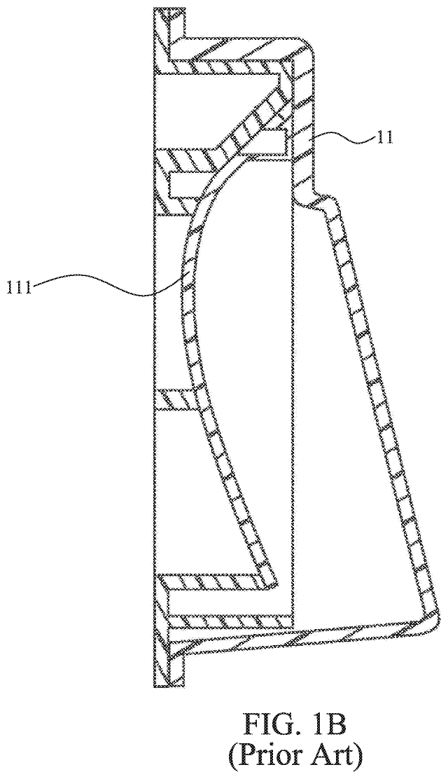

FIG. 2 is a schematic illustrating perspective view of the respirator mask according to first preferable embodiment of the present invention;

FIG. 3 is a schematic illustrating exploded perspective view of the respirator mask according to first preferable embodiment of the present invention;

FIG. 4 is a schematic illustrating section view along the A-A direction in FIG. 2;

FIG. 5A is a schematic illustrating breathing out air onto the respirator mask by a user according to first preferable embodiment;

FIG. 5B is a schematic illustrating breathing in air via the respirator mask by a user according to first preferable embodiment;

FIG. 6 is a schematic illustrating perspective view of the respirator mask according to second preferable embodiment of the present invention;

FIG. 7 is a schematic illustrating exploded perspective view of the respirator mask according to second one preferable embodiment of the present invention;

FIG. 8 is a schematic illustrating section view along the B-B direction in FIG. 6;

FIG. 9A is a schematic illustrating breathing out air onto the respirator mask by a user according to the second preferable embodiment;

FIG. 9B is a schematic illustrating breathing in air via the respirator mask by a user according to the second preferable embodiment;

FIG. 10 is a schematic illustrating the respirator mask of the present invention according to third preferable embodiment;

FIG. 11 is a schematic illustrating the respirator mask of the present invention according to fourth preferable embodiment;

FIG. 12A is a schematic illustrating using the respirator mask of the fourth preferable embodiment by a user; and

FIG. 12B is a schematic illustrating using the respirator mask of the fourth preferable embodiment by a user.

### DETAILED DESCRIPTION OF PREFERRED EMBODIMENTS

In order to further understand the structure, usage and features of the present disclosure more clearly, the present disclosure is described in detail below with references to the accompanying drawings and specific preferred embodiments.

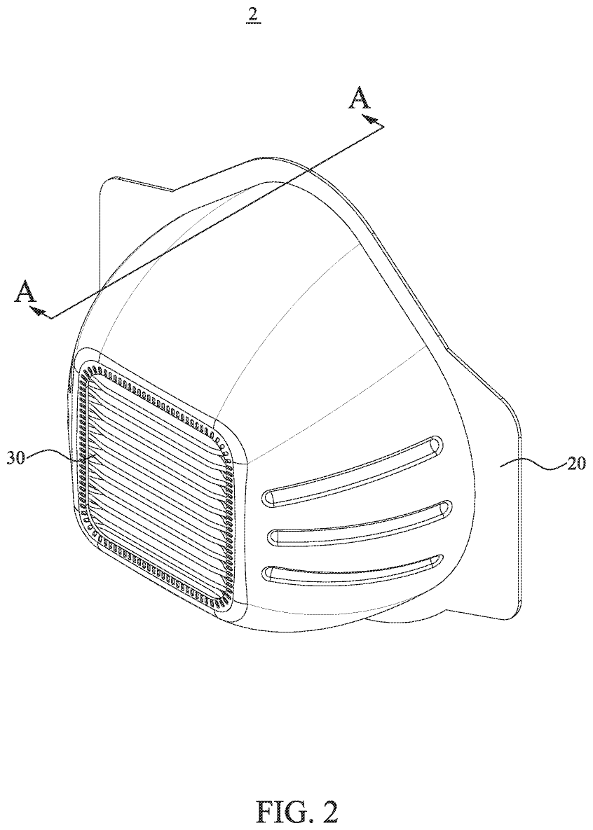

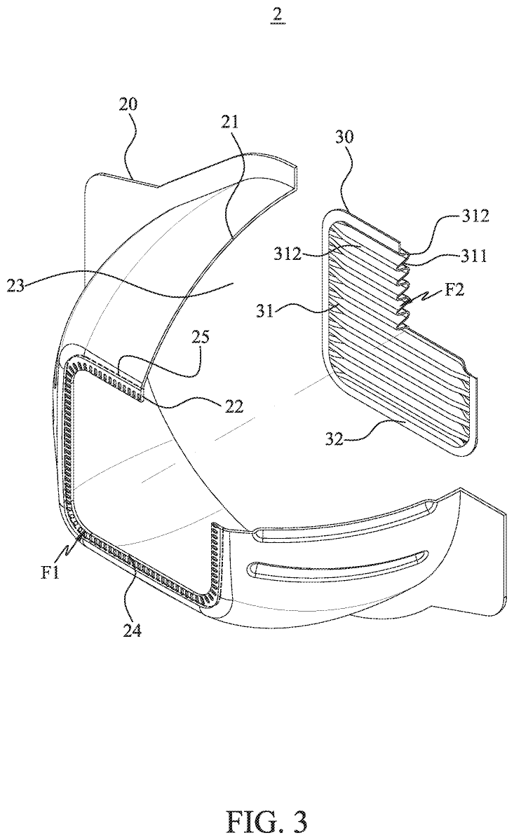

Please refer to FIGS. 2, 3 and 4. In first preferable embodiment, a respirator mask 2 provided by the present invention is adapt to cover the mouth and the nose of a user and mainly comprises a mask body 20 and a filter unit 30. Wherein, entire shape of the mask body 20 shows a three dimensional form which includes a three dimensional curve portion 21 and a flat plane portion 22. The plane portion 22 forms at one end of the curve portion 21. As shown in the figure, the curve portion 21 and the plane portion 22 jointly constitute a three-dimensional accommodation space 23 covering a user's mouth and nose, while a ventilation opening 24 is formed at a local portion of the plane portion 22 corresponding to the mouth and the nose for communicating with the three-dimensional accommodation space 23. Wherein, a plane section 25 at the periphery of the ventilation opening 24 is arranged at one side of the plane portion 22 close to the mouth and the nose of the user, and an end face of the ventilation opening 24 away from the three-dimensional accommodation space 23 forms a vent flux surface F1 through which the air can flow.

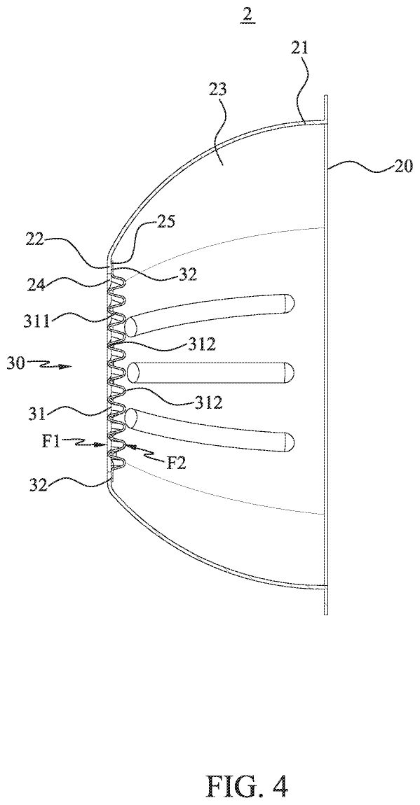

Furthermore, the filter unit 30 comprises two portions which are a filter portion 31 and a connection portion 32. The filter portion 31 has a form size corresponding to a diameter of the ventilation opening 24 and is used for filtering out the dirt in the air. The connection portion 32 has a contour diameter larger than the diameter of the ventilation opening 24 and forms at the periphery of the filter portion 31. Please refer to FIG. 4, the filter portion 31 is arranged with a plurality of connection sheets 311 sequentially connecting with each other for making the filter portion 31 show a folding structure able to change form. In the present embodiment, opposite ends of the connection sheet 311 each separately connect with one other connection sheet 311, such that every connection between two of the connection sheets 311 separately forms a bend segment 312. Every surface area of the plurality of connection sheets 311 jointly constitutes a fold flux surface F2 through which the air can flow. In the present embodiment, the mask body 20 and the filter unit 30 are made of different air permeable materials and the air permeability of the filter unit 30 is better than that of the mask body 20. Furthermore, an area of the fold flux surface F2 is larger than that of the vent flux surface F1.

As shown in the figure, the connection portion 32 of the filter unit 30 is hot pressed onto the plane section 25 such that the connection portion 32 is located in the interior of the three-dimensional accommodation space 23 to make the connection portion 32 overlap the mask body 20. Therefore, the filter portion 31 of the filter unit 30 is aligned with the ventilation opening 24 and the filter unit 30 further seals the ventilation opening 24. Wherein, when the filter unit 30 is attached to the mask body 20, the filter unit 30 is located at one side of the mask body 20 close to the mouth and nose of the user, such that the fold flux surface F2 and the vent flux surface F1 do not intersect. In one preferable embodiment, a part of the bend segment 312 of the filter portion 31 is inside the ventilation opening 24 and the remaining part of the bend segment 312 of the filter portion 31 protrudes out of the ventilation opening 24 and into the interior of the three-dimensional accommodation space 23. In another preferable embodiment, the entire bend segment 312 is located at the same side of the vent flux surface F1.

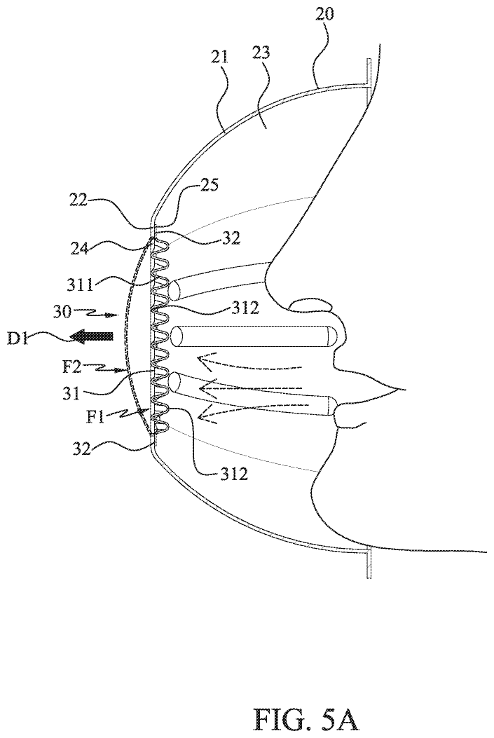

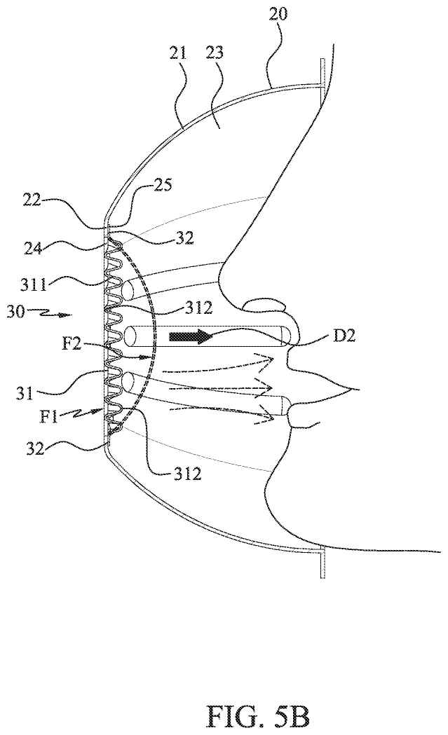

Please refer to FIG. 5A. The respirator mask 2 is worn on the mouth and the nose of a user and the three-dimensional accommodation space 23 of the mask body 20 covers the mouth and the nose of the user. Then when the user exhales onto the respirator mask 2, the connection sheets 311 of the filter unit 30 each will deform to make the every bend segment 312 move in a first direction D1. Therefore, the filter portion 31 of the filter unit 30 bulges outward in the direction away from three-dimensional accommodation space 23 to change the contour of the fold flux surface F2, and thus the vent flux surface F1 intersects with the fold flux surface F2. Therefore, the filter portion 31 in the bulge state increases a surface area of contacting the air and further increases the range of an area through which the air can flow on the respirator mask 2, such that during exhalation most air exhaled by the user not only flow through the mask body 20 to be discharged to the external space, but also flow through the filter portion 31 of the filter unit 30 to be discharged to the external space. Relatively, the user can easily breathe out the air from the mouth while wearing the respirator mask 2 and the resistance of blocking air by the respirator mask 2 is reduced. In the present embodiment, the first direction D1 is parallel to the opening direction of the ventilation opening 24.

Please refer to FIG. 5B. When a user inhales while wearing the respirator mask 2, the every connection sheet 311 of the filter unit 30 deforms to make the bend segment 312 move in a second direction D2 opposite to the first direction D1. Therefore, the filter portion 31 of the filter unit 30 inwardly bulges toward the mouth and the nose of the user and thus the vent flux surface F1 does not intersect with the fold flux surface F2. Therefore, the filter portion 31 in the bulge state increases a surface area of contacting the air and further increases the range of an area through which the air can flow on the respirator mask 2, such that during inhalation the user can easily breathe in the air of the external space into the mouth via the filter portion 31.

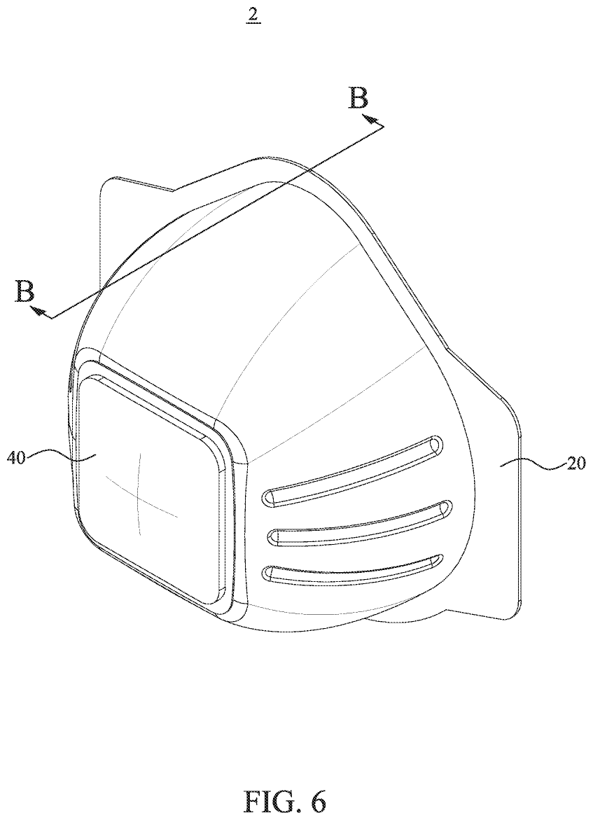

Please refer to FIG. 6. In second preferable embodiment, the difference compared to the first preferable embodiment is that the respirator mask 2 further comprises a covering body 40. Therefore, the respirator mask 2 mainly comprises the mask body 20, the filter unit 30 and the covering body 40 in this embodiment.

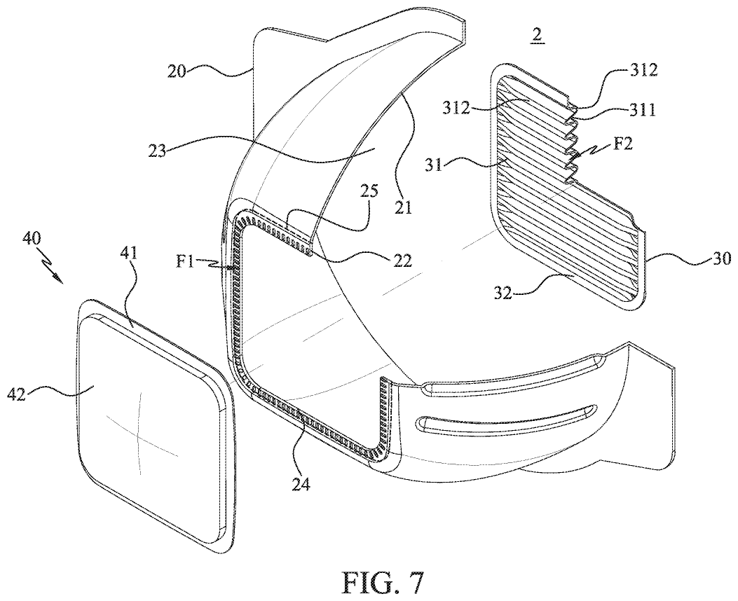

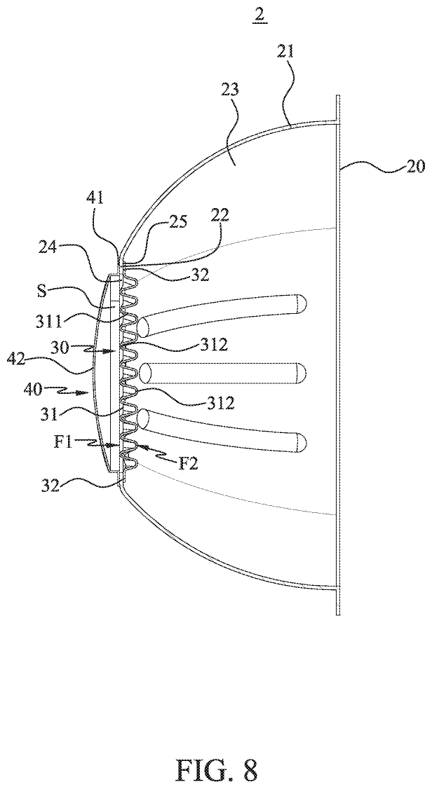

Please refer to FIGS. 6, 7, and 8. A form contour of the covering body 40 is larger than the diameter of the ventilation opening 24, and the peripheral portion of the covering body 40 forms a joint portion 41. The remaining part of the covering body 40 forms a covering portion 42 at the center of the joint portion 41. Wherein the joint portion 41 is hot pressed and attached to one side of the mask body 20 opposite to the connection portion 32, such that the joint portion 41 and the connection portion 32 are separately located at opposite sides of the mask body 20. Now, the covering portion 42 covers the ventilation opening 24, and the covering portion 42 is at one side of the filter unit 30 to prevent the filter unit 30 being exposed. Therefore, the aesthetics of the respirator mask 2 is increased, and the covering portion 42 can optionally move away from or close to the ventilation opening 24. As shown in the figure, when the covering body 40 is attached to the mask body 20, an accommodation space S is formed between the covering portion 42 and the mask body 20 and a size of the accommodation space S can be enlarged or reduced as the covering portion 42 moves away from or close to the ventilation opening 24. In the present embodiment, the mask body 20 and the covering body 40 are made of the same air permeable material while the filter unit 30 and the mask body 20 are made of different air permeable materials. In addition, the air permeability of the filter unit 30 is better than the air permeability the mask body 20 and the covering body 40.

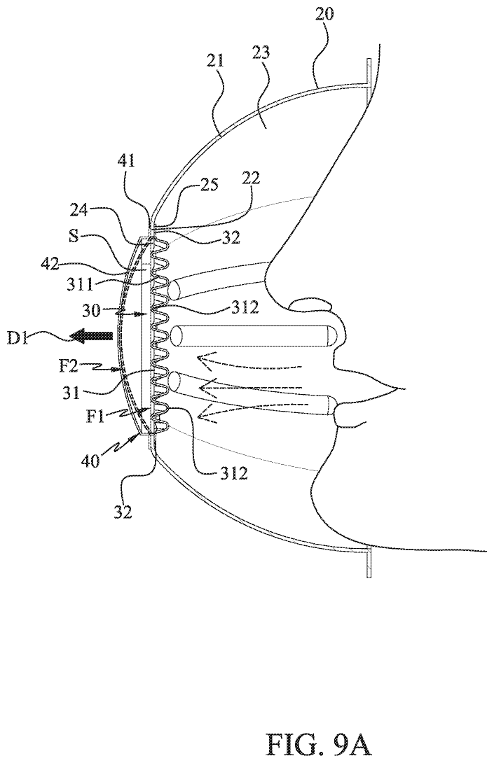

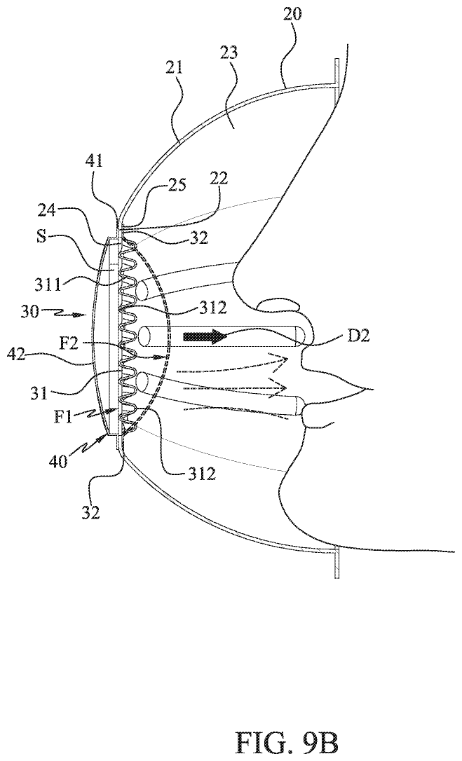

Please refer to FIG. 9A. The respirator mask 2 is worn on the mouth and the nose of a user, then when the user exhales onto the respirator mask 2, the connection sheets 311 of the filter unit 30 each will, like the first preferable embodiment, undergo deforming process to make the every bend segment 312, in a first direction D1, be gradually close to the covering body 40. Therefore, the filter portion 31 bulges toward the covering body 40 and enter the inside of the accommodation space S, such that the vent flux surface F1 intersects with the fold flux surface F2. Wherein when the filter portion 31 pushes against the covering portion 42 of the covering body 40, the covering portion 42 moves away from the ventilation opening 24 to enlarge the accommodation space S, and thereby the filter portion 31 in the bulge state increases a surface area of contacting the air and further increases the range of an area through which the air can flow on the respirator mask 2, such that during exhalation most air exhaled by the user is sequentially discharged from the filter portion 31 and the covering body 40 into the external space. The user thereby can easily breathe out the air from the mouth while wearing the respirator mask 2.

Please refer to FIG. 9B. When a user inhales while wearing the respirator mask 2, the every connection sheet 311 of the filter unit 30 will, like the first preferable embodiment, undergo deforming process to make the every bend segment 312 move away from the covering body 40 and make the filter portion 31 of the filter unit 30 bulges inwardly in a second direction D2. Therefore, the filter portion 31 in the bulge state increases a surface area of contacting the air and further increases the range of an area through which the air can flow on the respirator mask 2, such that during inhalation the user can easily breathe in the air of the external space sequentially via the covering body 40 and the bulging filter portion 31 into the mouth.

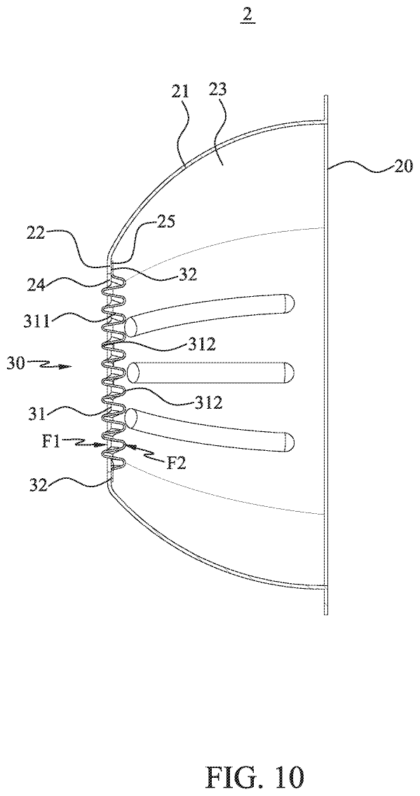

Please refer to FIG. 10. In third preferable embodiment, the difference compared to the first preferable embodiment is positional relationship between the vent flux surface F1 and the bend segment 312, while the structure type of the mask body 20 and the filter unit 30 are the same as those in the first preferable embodiment which thereby will not be repeated in the present embodiment. As shown in the figure, a part of the bend segment 312 projects out of one side of the ventilation opening 24 and the remaining part of the bend segment 312 projects out of the other side of the ventilation opening 24. Therefore, the plurality of the bend segments 312 are distributed at opposite sides of the vent flux surface F1. As for the practical form of usage, it is the same as one in the first preferable embodiment and will not be repeated in this embodiment.

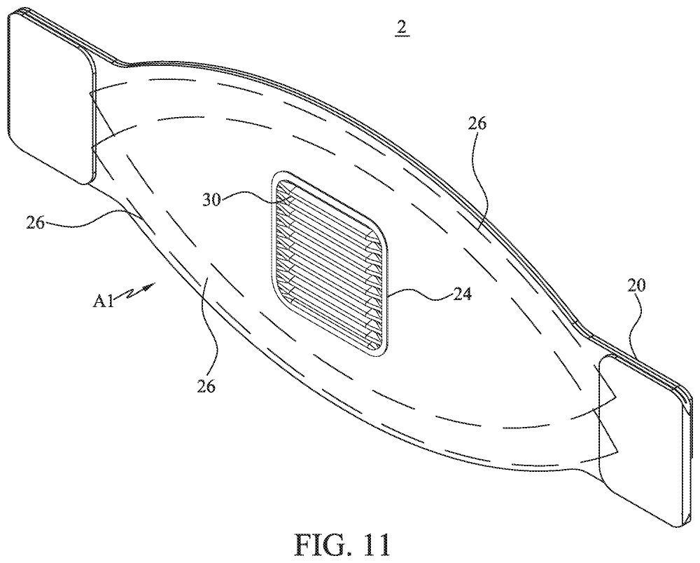

Please refer to FIG. 11. In the fourth preferable embodiment, the difference compared to the first preferable embodiment is the form of the mask body 20. And the structure type of the filter unit 30 is the same as that in the first preferable embodiment; the filter unit 30 thereby will not be repeated in this embodiment.

As shown in the figure, the mask body 20 comprises a plurality of sheet bodies 26 connecting with each other. The plurality of sheet bodies 26 can collapse to each other or be unfolded to change the relative position between the sheet body 26 and one other sheet body 26. Furthermore, the ventilation opening 24 of the mask body 20 is formed on one of the sheet bodies 26.

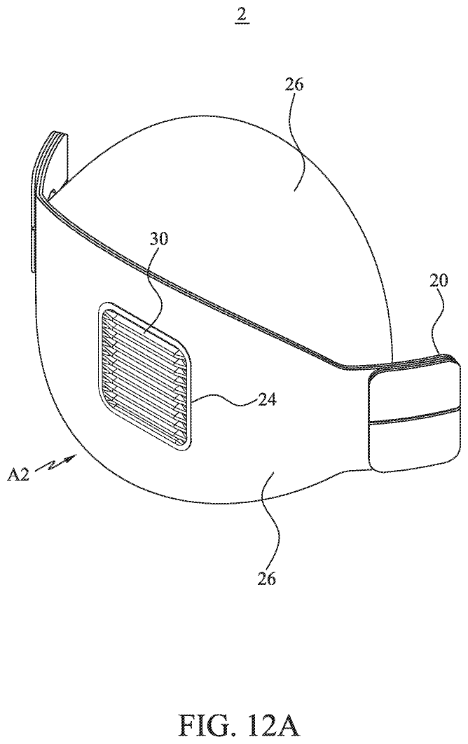

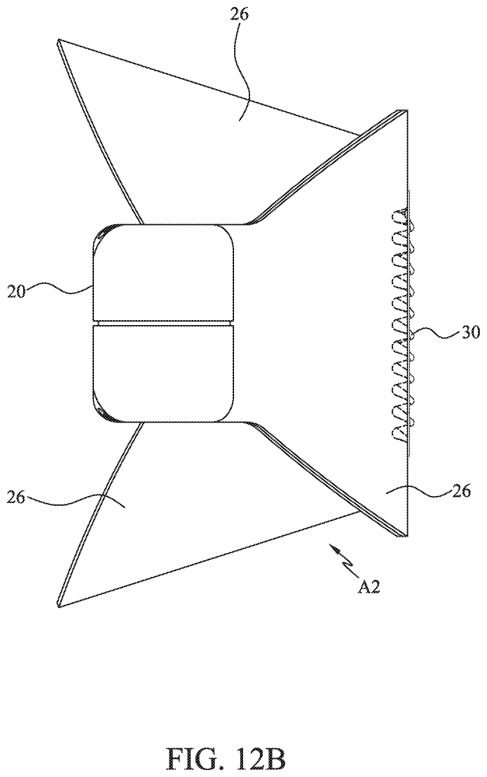

Please refer to FIGS. 12A and 12B. During practical application, a user pulls the two of the sheet bodies 26 to make the plurality of the sheet bodies 26 unfolded away from each other so as to change the relative position between the sheet body 26 and one other sheet body 26. Therefore a state of the mask body 20 changes into an unfolded state A2 with three-dimensional from a collapsed state A1 with flat form and then the mask body 20 of the unfolded state A2 covers the mouth and nose of the user. Subsequently, when the user breathes in and out air, the filter portion 31 of the filter unit 30 is generated as one in the first preferable embodiment to make the respirator mask 2 increase the range of an area through which the air can flow.

The above-mentioned embodiments are used for conveniently describing the present invention, not further to limit it. For the person skilled in the art of the disclosure, without departing from the concept of the disclosure, simple modifications or changes can be made according to the claims and description of the present invention and should be included in the protection scope of the disclosure.

What is claimed is:

1. A respirator mask for covering the mouth and the nose of a user, comprising:
a mask body arranged with a ventilation opening, wherein one end face of the ventilation opening forms a vent flux surface through which the air can flow; and
a filter unit comprising a filter portion able to filter out the dirt and a connection portion forming at the periphery of the filter portion;
wherein the filter portion is arranged with a plurality of connection sheets connecting with each other for making the filter portion show a folding structure able to change form and surface areas of the plurality of connection sheets jointly constitute a fold flux surface through which the air can flow;
wherein an area of the fold flux surface is larger than the area of the vent flux surface, and the connection portion is attached to the mask body such that the filter portion is aligned with the ventilation opening, therefore the filter unit seals the ventilation opening.

2. The respirator mask according to claim 1, wherein the filter unit is located at one side of the mask body close to the mouth and the nose of the user, such that the fold flux surface does not intersect with the vent flux surface, and wherein the plurality of connection sheets can deform to change a contour of the fold flux surface, such that the vent flux surface intersects with the fold flux surface.

3. The respirator mask according to claim 1, wherein opposite ends of the connection sheet each separately connect with one other connection sheet, such that every connection between two of the connection sheets separately forms a bend segment in the filter portion, and wherein the connection sheets are all located at the same side of the vent flux surface or are distributed at opposite sides of the vent flux surface.

4. The respirator mask according to claim 1, wherein the filter portion has a size corresponding to a diameter of the ventilation opening and the connection portion is at the periphery of the filter portion, such that the connection portion has a contour diameter larger than the diameter of the ventilation opening and the connection portion thereby overlaps the mask body.

5. The respirator mask according to claim 1, wherein the mask body includes a curve portion showing a three dimensional form and a plane portion showing a flat form, and wherein the plane portion forms at one end of the curve portion close to the ventilation opening, and furthermore the plane portion is arranged with the ventilation opening as well as being used to attached to the connection portion of the filter unit.

6. The respirator mask according to claim 1, wherein the mask body comprises a plurality of sheet bodies connecting with each other, and the plurality of sheet bodies can be unfolded to change the relative position between the sheet body and one other sheet body, such that a state of the mask body changes into an unfolded state with three-dimensional from a collapsed state with flat form, and wherein the ventilation opening is formed on one of the sheet bodies.

7. The respirator mask according to claim 1, wherein the respirator mask further comprises a covering body having a form larger than the ventilation opening, and a part of the covering body forms a joint portion attached to one side of the mask body opposite to the connection portion, such that the remaining part of the covering body forms a covering portion at the center of the joint portion to cover the ventilation opening.

8. The respirator mask according to claim 7, wherein the covering portion can optionally move away from or close to the ventilation opening, and an accommodation space is formed between the covering portion and the mask body, and furthermore a size of the accommodation space can be enlarged or reduced as the covering portion moves away from or close to the ventilation opening.

9. The respirator mask according to claim 8, wherein the plurality of connection sheets can deform to enter the interior of the accommodation space when the user breathes out the air.

10. The respirator mask according to claim 7, wherein the mask body and the covering body are made of the same air permeable material while the filter unit and the mask body are made of different air permeable materials, and the air permeability of the filter unit is better than the air permeability of the mask body.
